(19) United States
(12) Patent Application Publication
(10) Pub. No.: US 2006/0154026 A1
(43) Pub. Date: Jul. 13, 2006

(54) Method and apparatus for providing inlaid indicia

(76) Inventor: James H. Budworth, Dickeyville, WI (US)

Correspondence Address: QUARLES & BRADY LLP, 411 E. WISCONSIN AVENUE, SUITE 2040, MILWAUKEE, WI, 53202-4497, US

(21) Appl. No.: 11/034,603

(22) Filed: Jan. 13, 2005

(51) Int. Cl. B32B 3/10

(52) U.S. Cl. 428/131

(57) ABSTRACT

An article includes a base member and an insert. The base member defines a first opening having a first sloped sidewall and at least one notch disposed in the sidewall. The insert is engaged with the base member and has a second sloped sidewall with a slope corresponding to a slope of the first sloped sidewall. The insert includes a tab defined along at least a portion of the second sloped sidewall. The tab interfaces with the notch. An article includes a base member and an insert. The base member defines a first opening having a first sloped sidewall. The insert is engaged with the base member and has a second sloped sidewall with a slope corresponding to a slope of the first sloped sidewall. At least a portion of the first sidewall is exposed and defines indicia.

### CROSS-REFERENCE TO RELATED APPLICATIONS

Not applicable.

### STATEMENT REGARDING FEDERALLY SPONSORED RESEARCH OR DEVELOPMENT

Not applicable

### BACKGROUND OF THE INVENTION

The present invention relates generally to display articles, such as logos and signs, and, more particularly, to a method and apparatus for providing inlaid indicia on a manufactured article.

Manufactured articles often include indicia, such as lettering and/or company logo information, to advertise or mark the article. Other display items, such as signs, use indicia to convey information. Various techniques are used to make the indicia appearing on the manufactured article distinct to get the attention of a viewer or to provide aesthetic appeal for the article. For example, contrast may be provided by varying the color of letters with respect to the color of the base material. Embossing or engraving techniques may also be used to provide a raised or three-dimensional appearance to the indicia.

Some techniques for generating visual effects for display articles are difficult or costly to implement. For example, embossing or engraving techniques may not be suitable for relatively thin material, as material must be removed or worked to achieve the desired affect. These techniques may also fail to provide a desired level of contrast for the item. For example, if a three-dimensional contrast is desired, an engraving technique may not remove sufficient material to create a perception of depth. While embossing does provide a relief effect, it may not be practical or sufficiently accurate for some materials.

This section of this document is intended to introduce various aspects of art that may be related to various aspects of the present invention described and/or claimed below. This section provides background information to facilitate a better understanding of the various aspects of the present invention. It should be understood that the statements in this section of this document are to be read in this light, and not as admissions of prior art.

### BRIEF SUMMARY OF THE INVENTION

One aspect of the present invention is seen in an article including a base member and an insert. The base member defines a first opening having a first sloped sidewall and at least one notch disposed in the sidewall. The insert is engaged with the base member and has a second sloped sidewall with a slope corresponding to a slope of the first sloped sidewall. The insert includes a tab defined along at least a portion of the second sloped sidewall. The tab interfaces with the notch.

Another aspect of the present invention is seen in an article including a base member and an insert. The base member defines a first opening having a first sloped sidewall. The insert is engaged with the base member and has a second sloped sidewall with a slope corresponding to a slope of the first sloped sidewall. At least a portion of the first sidewall is exposed and defines indicia.

These and other objects, advantages and aspects of the invention will become apparent from the following description. The particular objects and advantages described herein may apply to only some embodiments falling within the claims and thus do not define the scope of the invention. In the description, reference is made to the accompanying drawings which form a part hereof, and in which there is shown a preferred embodiment of the invention. Such embodiment does not necessarily represent the full scope of the invention and reference is made, therefore, to the claims herein for interpreting the scope of the invention.

### BRIEF DESCRIPTION OF THE SEVERAL VIEWS OF THE DRAWINGS

The invention will hereafter be described with reference to the accompanying drawings, wherein like reference numerals denote like elements, and:

FIG. 1 is a front view of a manufactured article having inlaid indicia;

FIG. 2 is a front view of a base member in the manufactured article of FIG. 1;

FIG. 3 is back view of the base member of FIG. 2;

FIG. 4 is a front view of an insert used in conjunction with the base member of FIG. 2 to form the inlaid indicia;

FIG. 5 is a back view of the insert of FIG. 4;

FIG. 6 is a side cross-section view of the insert of FIG. 4; and

FIG. 7 is a side cross section view of the base member of FIG. 2.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

One or more specific embodiments of the present invention will be described below. It is specifically intended that the present invention not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the present invention unless explicitly indicated as being “critical” or “essential.”

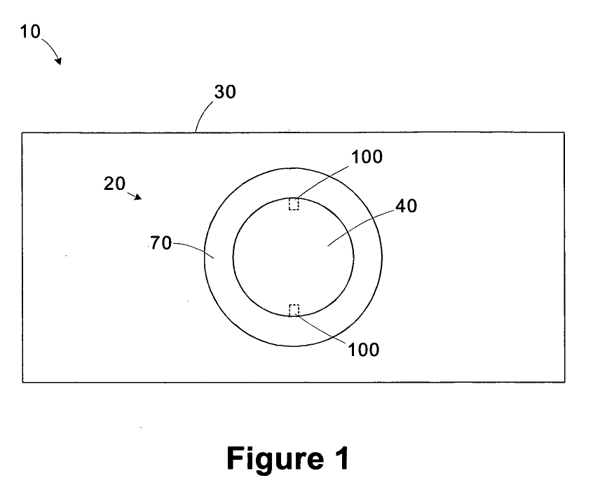

Referring now to the drawings wherein like reference numbers correspond to similar components throughout the several views and, specifically, referring to FIG. 1, the present invention shall be described in the context of a manufactured article 10 having inlaid indicia 20. The manufactured article 10 includes a base member 30 and an insert 40 that cooperate to form the inlaid indicia 20. In general, the inlaid indicia 20 may take the form of alphanumeric characters, logos, or any other type of marking or image. For example, the manufactured article 10 may be a sign with lettering and/or a company logo formed using a plurality of inserts 40. In another example, the inlaid indicia 20 may be formed in a functional part of an item, such as the exhaust pipe of a vehicle, to provide distinctiveness.

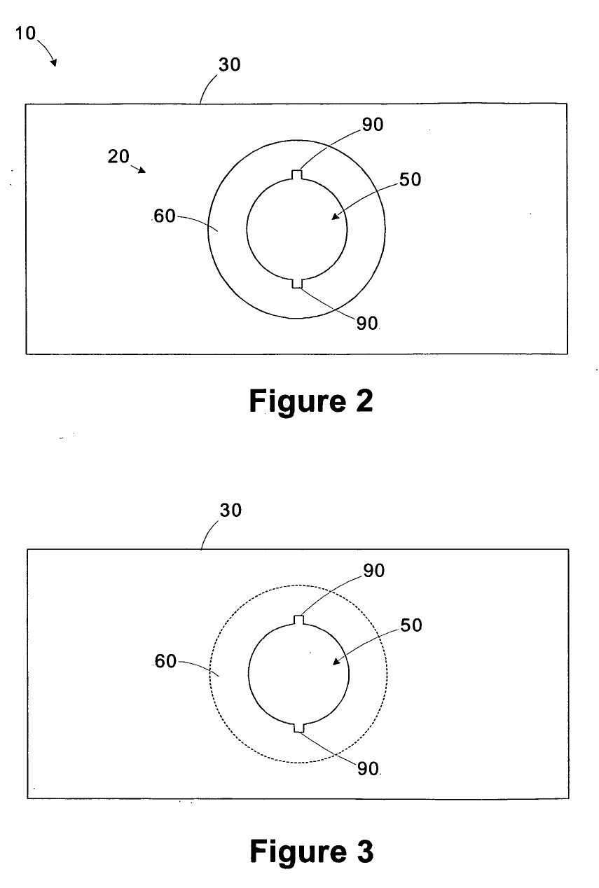

FIGS. 2 and 3 show front and back views of the base member 30, respectively. As shown in FIG. 2, the base member 30 defines an opening 50 having a sloped sidewall 60. The insert 40 fits within the opening 50 such that a portion 70 of the sidewall 60 remains visible. The insert 40 and the visible portion 70 define the inlaid indicia 20 and provides a three-dimensional effect. In the illustrated example shown in FIG. 1, the inlaid indicia 20 defines the letter “O”. Of course other shapes, such as other letters or characters or other shapes, may be defined. Multiple openings 50 and inserts 40 may be used to define words.

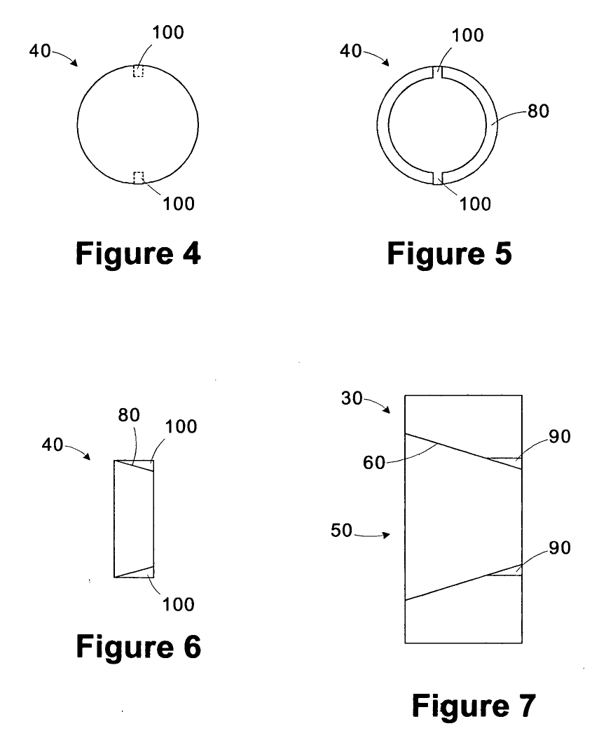

FIGS. 4, 5, and 6 show front, back, and side cross section views of the insert 40, respectively. The insert 40 has a sloped sidewall 80 with a slope corresponding to the slope of the sidewall 60 of the base member 30. When the insert 40 is engaged with the base member 30 the corresponding slopes of the sidewalls 60, 80 prevent the insert 40 from passing through the opening 50 in the base member 30. In the illustrated embodiment, the insert 40 is sized such that it is flush with respect to the base member 30 on the side opposite the exposed sidewall 70 when engaged therewith.

Turning now to FIG. 7, which illustrates a side cross-section view of the base member 30, and to FIG. 6, the sidewalls 60 define notches 90 that interface with corresponding tabs 100 defined on the insert 40. In general, the notches 90 and tabs 100 are sized to create an interference fit therebetween, (i.e., the tab 100 is slightly larger than the notch 90. The notches 90 and tabs 100 cooperate to secure the insert 40 within the opening 50 defined in the base member 30. In general, the notches 90 and tabs 100 are not visible when the inlaid indicia 20 is viewed. To achieve this effect, the notches 90 begin at a depth along the sidewall 60 where the width of the opening 50 corresponds to the width of the insert 40.

Although the base member 30 and insert 40 are illustrated as having planar surfaces, they may also be implemented using curved profiles. The inside diameters of the base member 30 and insert 40 may be the same, and the outside diameter of the of the insert 40 would be selected to match the intermediate diameter of the base member 30 at the point where the insert 40 fits within the opening 50. In yet another variation, only one of the base member 30 and the insert 40 may have a curved surface, and the other may be planar.

In some embodiments, the base member 30 and insert 40 may be formed without the notches 90 and tabs 100 and the insert 40 may be secured within the opening 50 using an alternative mounting means, such as an adhesive, bonding agent, or tack weld.

The dimensions of the base member 30 and insert 40 may vary depending on the particular application and materials used. Generally, thinner material may require a greater sidewall angle. The tolerances chosen may also depend on environmental factors. If materials with different coefficients of thermal expansion are used in an application with appreciable temperature variation, the tolerances may be adjusted to ensure the acceptability of the interference fit between the base member 30 and the insert 40.

In one embodiment, the base member 30 and insert 40 may be formed of similar or dissimilar metals that are shaped using a multi-axis laser. An exemplary manufacturing tool that may be employed is a Space Gear Mark II series laser offered commercially by Mazak Laser Corporation. Other manufacturing techniques, such as molding, casting machining, etc. may also be used. The base member 30 and insert 40 may be formed of virtually any material, such as metal, wood, plastic, etc.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. An article, comprising:
a base member defining a first opening having a first sloped sidewall and at least one notch disposed in the sidewall; and
an insert engaged with the base member and having a second sloped sidewall with a slope corresponding to a slope of the first sloped sidewall and a tab defined along at least a portion of the second sloped sidewall, wherein the tab interfaces with the notch.

2. The article of claim 1, wherein the first opening has a depth greater than a width of the insert.

3. The article of claim 1, wherein at least a portion of the first sloped sidewall is exposed.

4. The article of claim 3, wherein the exposed portion of the first sloped sidewall defines indicia.

5. The article of claim 4, wherein the indicia comprises an alphanumeric character.

6. The article of claim 1, wherein the tab and notch engage in an interference fit.

7. The article of claim 1, wherein a rear surface of the insert is flush with respect to a rear surface of the base member.

8. The article of claim 1, wherein the base member and insert have a curved profile.

9. An article, comprising:
a base member defining a first opening having a first sloped sidewall; and
an insert engaged with the base member and having a second sloped sidewall with a slope corresponding to a slope of the first sloped sidewall, wherein at least a portion of the first sidewall is exposed and defines indicia.

10. The article of claim 9, wherein the indicia comprises an alphanumeric character.

11. The article of claim 10, further comprising an adhesive securing the insert to the base member.

12. The article of claim 9, wherein a rear surface of the insert is flush with respect to a rear surface of the base member.

13. The article of claim 9, wherein the base member and insert have a curved profile.

14. A method for providing inlaid indicia, comprising:
forming a base member defining a first opening having a first sloped sidewall;
forming an insert having a second sloped sidewall with a slope corresponding to a slope of the first sloped sidewall; and
engaging the insert with the base member to exposing at least a portion of the first sloped sidewall, the exposed portion of the first sloped sidewall defining the inlaid indicia.

15. The method of claim 14, wherein forming the base member and the insert further comprises forming the base member and the insert using a laser.

16. The method of claim 14, wherein forming the base member and the insert further comprises molding the base member and the insert.

17. The method of claim 14, wherein the base member defines at least one notch disposed in the sidewall, the insert defines a tab defined along at least a portion of the second sloped sidewall, and engaging the insert with the base member further comprises engaging the tab on the insert with the notch on the base member.

18. The method of claim 14, further comprising adhesively securing the insert to the base member.

19. The method of claim 14, wherein engaging the insert with the base member until a rear surface of the insert is flush with respect to a rear surface of the base member.

20. The method of claim 14, wherein forming the base member and the insert further comprise forming the base member and insert having curved profiles.
